(19) United States
(12) Patent Application Publication
(10) Pub. No.: US 2020/0355220 A1
(43) Pub. Date: Nov. 12, 2020

(54) BEARING ASSEMBLY

(71) Applicant: Taurus Technologies Group, Inc., Grimsby (CA)

(72) Inventors: Stefan Magnusson, Grimsby (CA); Marta Magnusson, Grimsby (CA); Maxine Magnusson, Grimsby (CA)

(21) Appl. No.: 16/408,080

(22) Filed: May 9, 2019

(51) Int. Cl. F16C 19/26; F16C 33/38

(52) U.S. Cl. CPC F16C 19/26; F16C 33/38

(57) ABSTRACT

An improved roller bearing assembly is disclosed. The improved roller bearing assembly incorporates roller elements having an axially connected cage or spacer connection point which allows the use of a flexible corded or connected spacer assembly. This allows the use of less cage or spacer assembly material than traditional bearing cage designs. It also allows for easier assembly and disassembly of the roller bearing assembly and reduces parasitic drag or friction by reducing the size and cross-section of the cage or spacer assembly. Alternate embodiments incorporating magnets for electromagnetic interaction, vanes for fluid interaction, and offset configuration for the cage elements are also disclosed.

This invention relates to an improved roller bearing assembly wherein the roller elements of the roller bearing have a spacing maintained by a system of core spacer members linked by a cord.

### INCLUSION BY REFERENCE

Previously filed United States of America Patent Application titled IMPROVED BEARING ASSEMBLY with an application filing date of Sep. 5, 2017, in the United States Patent and Trademark Office, application Ser. No. 15/695,921, said application made by the same applicant, is hereby incorporated herein by reference.

### BACKGROUND OF THE INVENTION

The present invention relates to an improved bearing assembly. Bearings, generally, are simply surfaces or interfaces where moving parts of a device interface with each other in a non-engaged fashion. (E.G. gears or rack-and-pinion systems are not bearings for purposes of this context.) Historically, these surfaces have either slid against each other, or been provided with roller elements which minimize sliding friction and wear. The standard example of the latter is the ball bearing, which incorporates one or more spherical roller elements (“balls”) which are captive between two rotating members of the device. Rather than have a direct planar or linear interface between the rotating members, the balls bear any mechanical load and allow the rotating members to rotate freely against each other.

In U.S. patent application Ser. No. 15/695,921 (see DESCRIPTION OF THE PREFERRED EMBODIMENT, for purposes of this application referred to as the “IBA Application,”) an improved bearing assembly was disclosed which addresses many of the shortcomings of traditional ball bearings. However, the improved bearing assembly of the IBA Application could still benefit from further improvements in the assembly's construction.

The cage assembly shown in the IBA Application provides for cage elements which contain the roller elements—that is, the physical elements of the cage, which maintains the spacing of the roller elements for maximum bearing performance and to avoid roller element collisions which can damage the roller elements—have a traditional configuration in that the roller elements are partially surrounded by/enclosed by the cage elements. While this is suitable for many applications, a more efficient form of cage assembly which uses less material, weighs less, and allows for decreased parasitic drag or friction would be a useful invention.

A more efficient form of cage assembly which allows for offsetting the cord guides disclosed in the IBA Application would also be a useful invention.

The present invention addresses these concerns.

### SUMMARY OF THE INVENTION

Among the many objectives of the present invention is the provision of an improved roller bearing assembly which allows precise control of the spacing of roller elements in a roller bearing.

An additional objective of the present invention is the provision of an improved roller bearing assembly which allows for an axially mounted cage spacing assembly.

Another objective of the present invention is the provision of an improved roller bearing assembly which allows easier insertion and removal of individual roller elements from a roller bearing.

Still another objective of the present invention is the provision of an improved roller bearing assembly which reduces material usage in a roller bearing.

Yet another objective of the present invention is the provision of an improved roller bearing assembly which reduces parasitic drag and friction in a roller bearing.

Still another objective of the present invention is the provision of an improved roller bearing assembly which allows an offset cage element component.

Other objectives and advantages of the present invention will become apparent to those of ordinary skill in the art upon review of the disclosure hereof.

### BRIEF DESCRIPTION OF THE DRAWINGS

FIG. 1 depicts an overhead perspective view of the improved roller bearing assembly.

FIG. 2 depicts an individual roller element for use in the improved roller bearing assembly.

FIG. 3 depicts a first alternate embodiment of an individual roller element for use in the improved roller bearing assembly.

FIG. 4 depicts a second alternate embodiment of an individual roller element for use in the improved roller bearing assembly.

### DESCRIPTION OF THE PREFERRED EMBODIMENTS

Reference will now be made in detail to several embodiments of the invention that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, down, over, above, below, beneath, rear, and front, can be used with respect to the drawings. These and similar directional terms are not to be construed to limit the scope of the invention in any manner. The words attach, connect, couple, and similar terms with their inflectional morphemes do not necessarily denote direct or intermediate connections, but can also include connections through mediate elements or devices.

Though useful for many applications, the improved roller elements disclosed herein are particularly useful when incorporated into an improved bearing assembly like the one disclosed in the IBA Application, i.e. previously filed United States of America Patent Application titled IMPROVED BEARING ASSEMBLY with an application filing date of Sep. 5, 2017, in the United States Patent and Trademark Office, application Ser. No. 15/695,921.

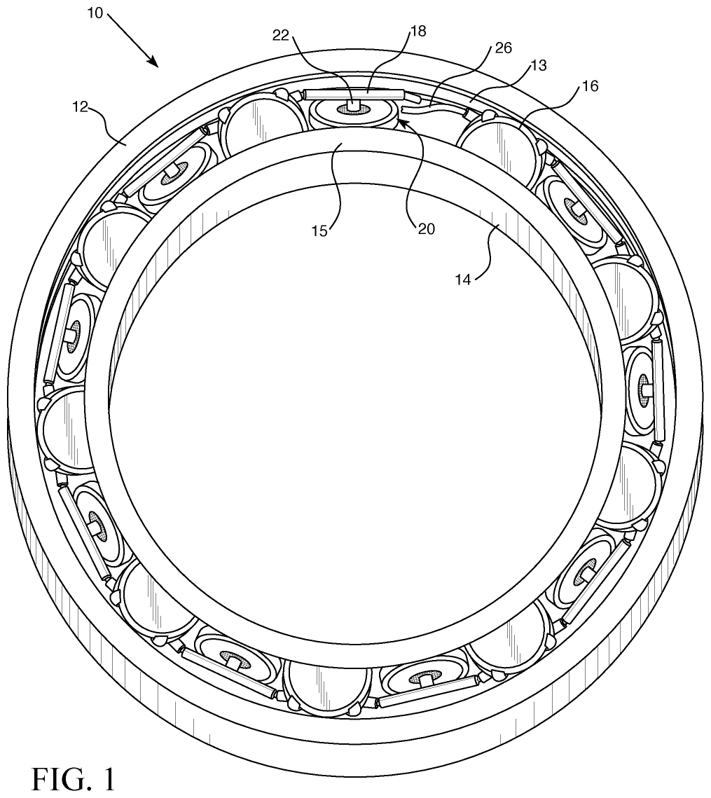

By referring to FIG. 1, the improved roller bearing assembly can be easily understood. A roller bearing assembly 10, similar to the one disclosed in the IBA Application, comprises outer race 12 and inner race 14. Individual roller elements, comprising roller(s) 16 and cage element(s) 22 which include(s) cord guide(s) 18, are contained in a raceway comprising outer raceway 13 (which is where roller 16 contacts outer race 12,) and inner raceway 15 (which is where roller 16 contacts inner race 14.) Cord 26 passes through the cord guides of all of the roller elements so that the cord guides maintain the appropriate orientation with respect to the roller elements and the raceway.

The purpose of the cage elements is to maintain the spacing between the roller elements so as to keep the load distribution between all of the roller elements as symmetrical as possible and to reduce the wear and tear on the rollers by load-balancing and the avoidance of collisions. To achieve these purposes, it is required that the cord guides be longer than the outer diameter of the rollers, such that the only contact between the roller elements is between the ends of tangent cord guides. (But see below description of an alternate embodiment affecting this requirement.) It is also required that cord 26 be of a length such that there is little or no slack in cord 26 when it is run though all of the cord guides so that they maintain the appropriate orientation and thus the desired spacing between the roller elements. (But see below description of an alternate method of connecting the cage elements.)

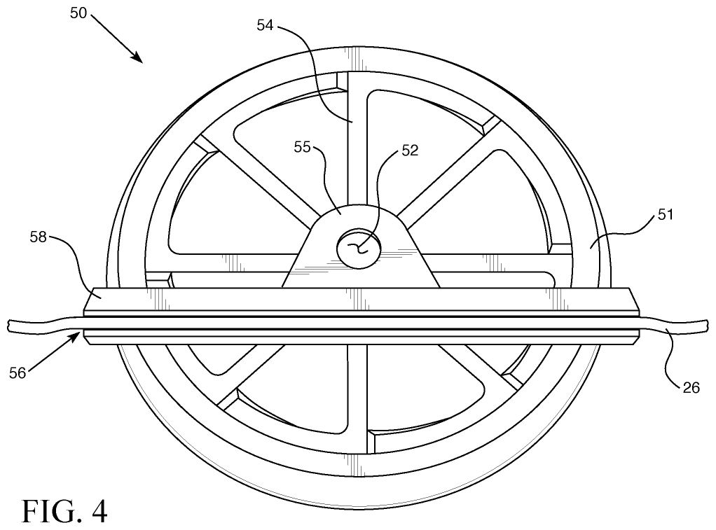

Cord 26 is shown with two separated ends for ease of understanding, but it is required that cord 26 be attached to form an effectively continuous piece. This can be done by sonic welding, the use of adhesive, thermal joining, physical clamps, or any other suitable means. If the cord release slot shown in FIG. 4 is used, cord 26 may also be manufactured as a single continuous circular piece.

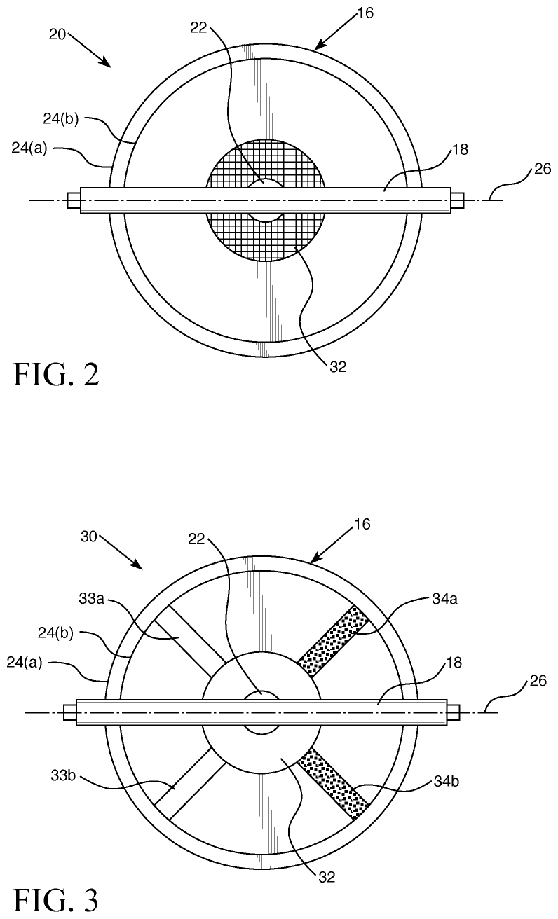

FIG. 2 shows an individual roller element 20. Roller 16 is a ring of some durable material, such as steel, titanium, metal alloy, ceramic, or thermoplastic. Roller 16 has outer roller surface 24(a) and inner surface 24(b). It is preferred, but not required, that roller 16 have sufficient elasticity such that it can be used under pre-load as that term is used in the IBA Application. If 140 this is done, it is preferred, but not required, that when the roller bearing assembly is assembled for use the orthogonal distance between outer raceway 13 and inner raceway 15 be slightly less than the diameter of roller 16 so that roller 16 can be placed under pre-load.

Concentric with roller 16 is elastomeric center 23, which fills the interior of roller 16 and which in turn is concentric with cage elements 22. It is preferred that elastomeric center 23 be made of some relatively elastic substance such as rubber or synthetic rubber. Although referred to as elastomeric, elastomeric center 23 is not required to be more elastic than is required to allow it to be set into roller 16. In an alternate embodiment (NOT SHOWN,) roller 16 is simply solid except for the concentric attachment to the cage elements and/or the rotary element between cord guide 18 and the rest of the roller element. In that alternate embodiment, the roller could also be entirely solid and the cage elements attached after fabrication by any appropriate means, including but not limited to welding, adhesive, or by making part of the cage element part of the casting/molding/extrusion of the roller.

It is required that if roller 16 is to be put under pre-load, that the entire roller including elastomeric center 23 if used be compressible enough to be inserted into the raceway under pre-load without damage or significant distortion. As shown in the IBA Application, an elastomeric dampener can also be added to the exterior of a solid roller. While this increases weight and drag, it allows for the use of a stronger solid disc as roller while including the vibration-dampening benefits of the elastomeric dampener.

Cage elements 22 comprise attachment 25 and cord channel 18. Attachment 25 interfaces the cage elements to the roller. It is required that cage elements 22 and roller and/or elastomeric center 23 be able to rotate freely in relation to each other so that cord guide 18 can maintain a fixed orientation along cord 26 while roller 16 rotates within the raceway. Any reasonable configuration which allows this can be used, including but not limited to an interior rotary bearing or two bearing surfaces which can move while in contact. The rotary connection can be concentric with roller 16 or between attachment 25 and cord guide 18.

FIG. 3 shows a first alternate embodiment of the roller element. Roller element 30 has axial elements 33(a), 33(b), 34(a), and 34(b) which attach roller 16 to central hub 32. Central hub 32 is then attached to cage elements 22 including cord guide 18 as in FIG. 2.

As with roller element 20, it is preferred, but not required, that roller element 30 as a whole be compressible enough that it can be used under pre-load as that term is used in the IBA Application. It is required that if roller 16 is to be put under pre-load, that the entire roller element including the axial members and/or central hub 32 be compressible enough to be inserted into the raceway under pre-load without damage or significant distortion.

It is optional, but neither preferred nor required, that axial members 33(a), 33(b), 34(a), and 34(b) incorporate magnets. If this is done, electromagnetic braking and/or acceleration can be used to slow, stop, or accelerate the roller elements and whatever mechanical load(s) they are being used to allow to rotate. This also allows the roller bearing assembly to be used as a generator, including but not limited to the use of regenerative braking to recapture energy which would otherwise be wasted when the roller bearing assembly is slowed or stopped.

It is optional, but neither preferred nor required, that axial members 33(a), 33(b), 34(a), and 34(b) incorporate vanes, fins, or other pitched or curved surfaces such that any fluid medium in the raceway is impelled by the motion of the roller elements or such that the roller elements can be impelled by the pressure of the fluid medium. This allows the roller bearing to be used as a pump or to be slowed, stopped, or accelerated by applying pressure to the fluid medium.

FIG. 4 shows a second alternate embodiment of the roller element. Roller element 50 comprises outer ring 61 which is connected to a central hub (not shown) by axial members 54. Axial members 54 can comprise vanes for use in fluid and/or incorporate magnets as disclosed in the description of FIG. 3. Cage element 55 interfaces with the central hub via a bearing surface or rotary bearing (not shown). It is required that ring roller 60 be able to rotate freely in relation to cage element 55 about rotary point 52. Cord guide 58 is affixed to cage member 55. It is preferred, but not required, that cord guide 58 and cage element 55 be extruded, molded, machined, cast or otherwise formed from a single piece of material. In this second alternate embodiment, the long axis of cord guide 18 is offset from the center of roller element 50. This allows alternate configurations of the entire roller bearing assembly, including alternate attachment configurations between the roller and the central hub. This configuration of cage element 55 can also be used with the roller and elastomeric center and/or solid roller configuration of FIG. 2.

It is optional, but neither preferred nor required, to include release slot 56 in cord guide 58. This allows a cord or other continuous retaining element such as cord 26 to be passed through cord guide 58, or removed therefrom, without having to disassemble the bearing assembly. It is optional, but neither preferred nor required, to include an analogous release slot in cord guide 18 or in other embodiments of the invention or the IBA. Whether or not release slot 56 is included in cord guide 58, cord 26 or other retaining member can then be passed through cord guide 58 and the cord guides of all the other cage members of the ring rollers incorporated in the bearing assembly to form a completed cage. This will cause the desired spacing to be maintained.

It is optional, but neither preferred nor required, to allow for the ends of cord guide 18, in any of the configurations disclosed herein, to attach only to the tangent cord guide affixed to the tangent ring rollers in the bearing assembly. If this is done, instead of a single cord, individual connections of whatever type (not shown) could connect the cage elements to form the cage and maintain the desired spacing. These attachments could be made via attachment members of any suitable type (e.g. pinch rings which pass through holes at the end of the cord guides) or by allowing the ends of cord guide 64 to mechanically interface (e.g. by terminating one end of the cord guide in a hook and the other end in a ring.) It is required that however the ends of cord guide 64 connect to other cord guides, that the connection both maintain the desired spacing and allow for unimpaired rotation of the ring rollers in the bearing assembly.

It is optional, but neither preferred nor required, to include independent spacer elements (analogous to beads on a string) which can go between some or all of the cord guides in any described embodiment of the improved roller bearing assembly. This allows more precise control of spacing between the individual roller elements. One or more spacers can also be added after a period of operation to maintain spacing if the cord stretches. It is optional, but neither preferred not required, that the spacer elements be made of less durable material than the cord guides, This will provide the advantage that the spacer elements will wear quicker than the cord guides and thus suffer the majority of frictional wear and damage, saving wear and tear on the more complex and expensive roller elements. If the spacers incorporate a release slot (analogous to release slot 56 in FIG. 4,) it is a simple and efficient procedure to remove the spacer elements for maintenance or spacing adjustment without having to disassemble the improved bearing assembly. If spacer elements are included, so long as they are of sufficient length in the dimension along which the cord or other connector travels, it removes the requirement that the cord guides be longer than the outside diameter of the rollers.

It will be apparent to those of ordinary skill in the art that the embodiments herein could be combined in varied combination or as a single unit, granting the improvements of each to a single bearing assembly.

While various embodiments and aspects of the present invention have been described above, it should be understood that they have been presented by way of example only, and not limitation. Thus, the breadth and scope of the present invention should not be limited by any of the above exemplary embodiments.

This application—taken as a whole with the abstract, specification, and drawings being combined—provides sufficient information for a person having ordinary skill in the art to practice the invention as disclosed herein. Any measures necessary to practice this invention are well within the skill of a person having ordinary skill in this art after that person has made a careful study of this disclosure.

Because of this disclosure and solely because of this disclosure, modification of this device and method can become clear to a person having ordinary skill in this particular art. Such modifications are clearly covered by this disclosure.

What is claimed and sought to be protected by Letters Patent is:

1) A bearing assembly comprising:
a) A raceway, comprising an inner bearing surface and an outer bearing surface;
b) At least two rollers, the at least two rollers being captive inside the raceway, each ring roller having an inner roller surface and an outer roller surface, the outer roller surface coming into contact with the outer bearing surface and the inner bearing surface;
c) A cage, the cage comprising at least two individual cage segments, each individual cage segment including a cord channel and an attaching member, each attaching member rotably affixed to a center of one of the at least two rollers; and,
d) A cord, the cord passing through all of the cord channels.

2) A bearing assembly as in claim 1, further comprising:
e) At least two elastomeric centers, one of the at least two elastomeric centers located inside one of each of the at least two rollers and affixed to the inner roller surfaces thereof such that each of the rollers has one of the elastomeric centers located inside it.

3) A bearing assembly as in claim 1, wherein the at least two rollers have an external diameter, the external diameter being the distance between two diametrically opposed points on the outer roller surface, and the external diameter is larger than an average distance between the outer bearing surface and the inner bearing surface when an external load is not present, causing a pre-load to exist when the at least two rollers are present between the inner bearing surface and the outer bearing surface.

4) A bearing assembly as in claim 2, wherein the at least two rollers have an external diameter, the external diameter being the distance between two diametrically opposed points on the outer roller surface, and the external diameter is larger than an average distance between the outer bearing surface and the inner bearing surface when an external load is not present, causing a pre-load to exist when the at least two rollers are present between the inner bearing surface and the outer bearing surface.

5) A bearing assembly as in claim 1 wherein the at least two rollers comprises at least two solid discs, and further comprising:
e) At least two first external dampeners, each of the at least two first external dampeners being affixed to a first face of one of the at least two solid discs; and,
f) At least two second external dampeners, each of the at least two second external dampeners being affixed to a second face of one of the at least two solid discs.

6) A bearing assembly as in claim 1 wherein each of the at least two rollers comprises a solid disc, and further comprising:
e) An external ring member, affixed to a circumference of the solid disc.

7) A bearing assembly as in claim 1, wherein the cord channel is offset from the center of the roller such that a diameter of the roller is parallel to the cord channel but the diameter is not tangent to the cord channel.

8) A bearing assembly as in claim 7, further comprising:
e) At least two elastomeric centers, one of the at least two elastomeric centers located inside one of each of the at least two rollers and affixed to the inner roller surfaces thereof such that each of the rollers has one of the elastomeric centers located inside it.

9) A bearing assembly as in claim 7, wherein the at least two rollers have an external diameter, the external diameter being the distance between two diametrically opposed points on the outer roller surface, and the external diameter is larger than an average distance between the outer bearing surface and the inner bearing surface when an external load is not present, causing a pre-load to exist when the at least two rollers are present between the inner bearing surface and the outer bearing surface.

10) A bearing assembly as in claim 8, wherein the at least two rollers have an external diameter, the external diameter being the distance between two diametrically opposed points on the outer roller surface, and the external diameter is larger than an average distance between the outer bearing surface and the inner bearing surface when an external load is not present, causing a pre-load to exist when the at least two rollers are present between the inner bearing surface and the outer bearing surface.

11) A bearing assembly as in claim 7 wherein the at least two rollers comprises at least two solid discs, and further comprising:
g) At least two first external dampeners, each of the at least two first external dampeners being affixed to a first face of one of the at least two solid discs; and,
h) At least two second external dampeners, each of the at least two second external dampeners being affixed to a second face of one of the at least two solid discs.

12) A bearing assembly as in claim 7 wherein each of the at least two rollers comprises a solid disc, and further comprising:
f) An external ring member, affixed to a circumference of the solid disc.

13) A bearing assembly as in claim 1, wherein the cord guide has a cord release slot which allows the cord to be inserted into and removed from the cord channel while the cord forms a single continuous piece.

14) A bearing assembly as in claim 2, wherein the cord guide has a cord release slot which allows the cord to be inserted into and removed from the cord channel while the cord forms a single continuous piece.

15) A bearing assembly as in claim 3, wherein the cord guide has a cord release slot which allows the cord to be inserted into and removed from the cord channel while the cord forms a single continuous piece.

16) A bearing assembly as in claim 4, wherein the cord guide has a cord release slot which allows the cord to be inserted into and removed from the cord channel while the cord forms a single continuous piece.

17) A bearing assembly as in claim 5, wherein the cord guide has a cord release slot which allows the cord to be inserted into and removed from the cord channel while the cord forms a single continuous piece.

18) A bearing assembly as in claim 6, wherein the cord guide has a cord release slot which allows the cord to be inserted into and removed from the cord channel while the cord forms a single continuous piece.

19) A bearing assembly as in claim 7, wherein the cord guide has a cord release slot which allows the cord to be inserted into and removed from the cord channel while the cord forms a single continuous piece.

20) A bearing assembly as in claim 11, wherein the cord guide has a cord release slot which allows the cord to be inserted into and removed from the cord channel while the cord forms a single continuous piece.

21) A bearing A bearing assembly comprising:
a) A raceway, comprising an inner bearing surface and an outer bearing surface;
b) At least two rollers, the at least two rollers being captive inside the raceway, each ring roller having an inner roller surface and an outer roller surface, the outer roller surface coming into contact with the outer bearing surface and the inner bearing surface;
c) A cage, the cage comprising at least two individual cage segments, each individual cage segment including a cord channel and an attaching member, each attaching member rotably affixed to a center of one of the at least two rollers;
d) A cord, the cord passing through all of the cord channels; and,
e) At least one spacer, the spacer having a spacer cord channel, the cord passing through the spacer cord channel when the spacer is placed between any of the at least two individual cage segments.

22) A bearing assembly as in claim 21, wherein the cord channel has a cord release slot which allows the cord to be inserted into and removed from the cord channel while the cord forms a single continuous piece.

23) A bearing assembly as in claim 21, wherein the spacer cord channel has a spacer cord release slot which allows the cord to be inserted into and removed from the spacer cord channel while the cord forms a single continuous piece.

24) A bearing assembly as in claim 22, wherein the spacer cord channel has a spacer cord release slot which allows the cord to be inserted into and removed from the spacer cord channel while the cord forms a single continuous piece.
